(19) United States
(12) Patent Application Publication
(10) Pub. No.: US 2008/0234143 A1
(43) Pub. Date: Sep. 25, 2008

(54) Mechanical methods for producing substrates having selectively immobilized molecules

(75) Inventor: Alex DeWinter, San Mateo, CA (US)

Correspondence Address: Pacific Biosciences of California, Inc., 1505 Adams Drive, Menlo Park, CA, 94025, US

(73) Assignee: Pacific Biosciences of California, Inc., Menlo Park, CA (US)

(21) Appl. No.: 12/077,744

(22) Filed: Mar. 20, 2008

Related U.S. Application Data
(60) Provisional application No. 60/919,788, filed on Mar. 23, 2007.

(51) Int. Cl. C40B 50/14

(52) U.S. Cl. 506/30

(57) ABSTRACT

Methods, systems and substrates for providing molecules of interest in selected regions of substrates for use in analytical operations. Methods employ mechanical methods of applying force for the removal of molecules of interest from other than the desired locations on a substrate.

### CROSS-REFERENCE TO RELATED APPLICATIONS

This application claims priority to Provisional U.S. Patent Application No. 60/919,788, filed Mar. 23, 2007, the full disclosure of which is hereby incorporated by reference in its entirety for all purposes.

### STATEMENT REGARDING FEDERALLY SPONSORED RESEARCH

Not Applicable

### BACKGROUND OF THE INVENTION

There are a wide range of analytical operations that may be benefited from the ability to analyze molecules discretely positioned in different regions of substrates. For example, in molecular arrays, such as GeneChip® or other nucleic acid array technologies (available from Affymetrix, Inc.), discrete groups of oligonucleotides are provided in discrete regions of substrates in order to facilitate determination of the presence and identity of nucleic acids that hybridize to the different oligonucleotides. In other cases, rather than provide discretely positioned different molecules, it is desirable to provide the same or similar molecules isolated from each other on a substrate surface, so as to provide discrete reaction regions that may be separately interrogated, either or both of chemically and/or optically. In particular, by providing discrete molecules or groups of molecules, such molecules may be provided with different reaction conditions, and/or may be subjected to individual optical monitoring.

A number of approaches have been described for providing these separated reaction mixtures. For example, in the field of nucleic acid sequence determination, a number of researchers have proposed single molecule, or low concentration approaches to obtaining sequence information in conjunction with the template dependent synthesis of nucleic acids by the action of polymerase enzymes.

The various different approaches to these sequencing technologies offer different methods of monitoring only one or a few synthesis reactions at a time. For example, in some cases, the reaction mixture is apportioned into droplets that include low concentrations of reactants. In other applications, certain reagents are immobilized onto surfaces such that they may be monitored without interference from other reaction components in solution. In still another approach, optical confinement techniques are used to ascertain signal information only from a relatively small number of reactions, e.g., a single molecule, within an optically confined area. Notwithstanding the availability of the above-described techniques, there are instances where further selectivity of reaction components for analysis would be desirable. The present invention meets these and a variety of other needs.

### BRIEF SUMMARY OF THE INVENTION

The present invention is directed to methods and systems for providing molecules of interest on selected regions of a substrate's surface through the application of mechanical forces to remove such molecules from areas where such molecules are not desired.

In a first aspect, the invention provides methods of producing an array of molecules of interest on a surface of a substrate. The methods comprise providing molecules of interest over a first surface of a substrate, and contacting selected portions of the first surface of the first substrate with a second surface wherein contact of the selected portions of the first surface with the second surface applies a force that results in removal of molecules of interest from the selected portions of the first surface.

In another aspect, the invention provides methods of producing a substrate having molecules of interest located in first selected regions thereof. The methods comprise providing a first substrate having a surface with molecules of interest disposed thereon. Second selected regions of the surface are contacted with a second substrate, where the second selected regions are different from the first selected regions. A force is then applied between the first substrate and the second substrate to remove the molecules of interest from the second selected regions.

### BRIEF DESCRIPTION OF THE DRAWINGS

FIG. 1 schematically illustrates the use of applied shear force on a portion of a substrate surface bearing molecules of interest.

FIG. 2 schematically illustrates the application of a shear force between two substrates to remove molecules of interest from raised portions of a substrate while retaining such molecules on other portions of the surface.

FIG. 3 schematically illustrates the use of an adherent force to remove molecules of interest from selected portions of a substrate's surface.

FIG. 4 schematically illustrates an alternative method and system for the removal of molecules of interest from selected portions of a substrate's surface using an adherent force.

### DETAILED DESCRIPTION OF THE INVENTION

The present invention is directed to methods for providing arrays of active molecules provided in selected locations on a surface, where such methods utilize a physical or mechanical removal of the active molecules from other than selected locations on that surface. In particular, the methods of the invention utilize mechanical, rather than chemical, thermal, optical or other non mechanical methods for removal of active molecules from undesirable locations on a substrate surface.

The present invention may be applied to a broad range of different types of molecular arrays, where the molecules of interest are provided in certain regions of a substrate while being excluded from other parts of the substrate. A number of processes have been previously described for the selective deposition of molecules in certain substrate regions while being excluded from other regions.

As used herein, the active molecules of interest may include active molecules that are intended to interact with reagents in a final application, such as enzymes, antibodies, nucleic acids, lectins, highly charged groups, hydrophobic or hydrophilic groups, or the like. Alternatively, such active molecules of interest may include coupling or binding groups to which the ultimate interactive molecules of the end application are attached. Such coupling groups include chemical coupling groups, such as thiols, sulfhydryls, amines, amides, epoxides, hydroxyls, N-hydroxysuccinimide (NHS) esters, tosyl groups, tresyl groups, and the like, as well as specific coupling groups, such as avidin, streptavidin, biotin, antibodies, nucleic acids or other molecules that could be exploited to couple another molecule, such as an enzyme, to the surface.

These include, for example, the use of channel block methods or hydrophobically patterned regions in directing the molecules of interest to only the desired regions, selective patterning of activated surfaces using, e.g., photolithographic processes, where molecules only bind in the selectively activated regions. Other processes have been described for providing the active molecules uniformly over a surface followed by the selective removal of such molecules from the regions in which the molecules were not desired, using, e.g. photo cleavage and/or deactivation or ablation, or chemical or enzymatic removal.

The present invention, while aimed at the same goals of these previous methods, is generally directed to the use of mechanical methods for the removal of molecules of interest from the regions where such molecules are not desired. As used herein, the mechanical methods refer to removal of bound or adsorbed molecules through abrasive, shear, adhesive or other removal processes in which the surface of the substrate is contacted with another surface that serves to remove molecules from the point of contact.

In particular, the methods of the invention typically provide a first substrate having the molecules of interest deposited thereon. The molecules of interest are preferably provided in a substantially uniform layer on a first surface of the first substrate, although the invention does not necessarily require such uniform deposition. By substantially uniform layer is meant that the molecules of interest are dispersed substantially randomly across the overall surface rather than selectively positioned or immobilized. Such layers will include sparsely populated layers on surfaces up to and including uniform monolayers, multilayers, and the like.

A second surface is then contacted with the first surface of the first substrate whereby such contact results in the removal of the molecules of interest from the portion of the first surface contacted by the second surface. As noted previously, the contact between the second surface and portions of the first surface removes molecules of interest typically through the application of mechanical forces to the portion of the first surface. In particular, by contacting and moving the second surface relative to the first surface, shear or abrasive forces may result in removal of the molecules of interest from the contacted portion of the first surface. Alternatively, the second surface may have a stronger affinity or other capability to adhere or adsorb the molecules of interest from the first surface, whereupon movement of the second surface relative to the first surface results in removal of the molecules of interest from the portions of the first surface.

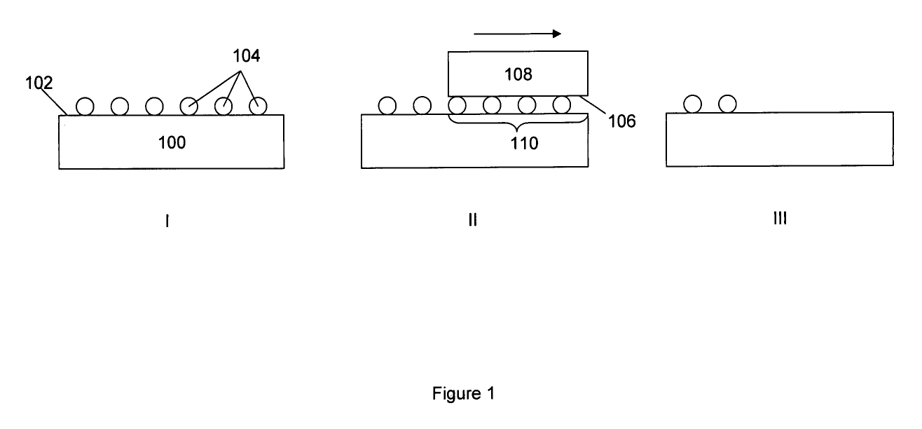

FIG. 1 schematically illustrates at least a first aspect of the invention. As shown, a substrate 100 includes a first surface 102 that has molecules of interest 104 disposed over it. A second surface 106, e.g., from a separate material or substrate 108, is then contacted with portions 110 of the first surface from where it is desired to remove the molecules. As shown, the contacting step involves the application of a shear force to the selected portions 110 of the first surface. Application of a shear force, e.g. as indicated by the arrows in panel II, may be provided by moving or wiping the second surface over the portions of the first surface. The application of this shear force is generally sufficient to dislodge any adsorbed or bound molecules, resulting in a substrate 100 that includes active molecules on its surface 102, but which have been substantially removed from the selected portions 110 of that surface. By substantially removed is meant that the population, concentration or density of the molecules of interest on the substrate surface is reduced by at least 75% as compared to the other regions of the surface, preferably at least 90% and more preferably at least 95% or even 99%, as measured by appropriate methods, e.g., activity, staining, affinity labeling, etc.

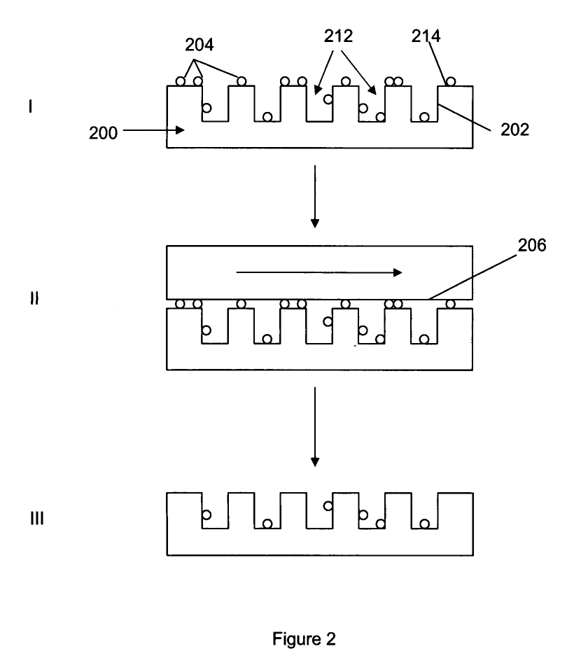

In related aspects, the methods of the invention are particularly useful where the first surface of the substrate comprises a structured surface, e.g., comprising wells, recesses or depressions therein, where it is desired to maintain the molecules of interest within the wells or recesses. In particular, and with reference to FIG. 2, a first substrate 200 is provided having a first surface 202 that includes wells 212 disposed therein. The molecules of interest 204 are again disposed over the entire first surface, including upon the interior surfaces of the wells 212. When the second surface 206 is brought into contact with the first surface 202 of the substrate 200, it only contacts those portions of the surface that are outside of the wells, e.g., top surfaces 214. Application of the shear force between the two surfaces, as indicated by the arrows in Panel II, then removes the molecules of interest from the top surfaces 214 while leaving those molecules of interest in the other surface regions, e.g., within the wells, undisturbed.

Typically, the second surface may be comprised of any of a variety of materials that is capable of providing the requisite shear force. For example, the second surface may comprise a rigid substrate, such as a glass or other silica based substrate material that is slid across the surface of the first substrate. Alternatively, metal, polymeric, or even natural fiber substrates may be employed to apply the shear forces.

In preferred aspects, the second substrate comprises a semi deformable material that is able to provide close contact with the surface of the first substrate. Particularly preferred materials include flexible polymer substrates, e.g., in slabs, films or sheets, such as silicone polymers like polydimethylsiloxanes (PDMS), and other organic polymers, such as polytetrafluoroethylene (PTFE or Teflon®), wax based materials, cellulose materials, such as cloths and wipes, e.g., Kimwipes®, nitrocellulose, polyvinyl difluoride membranes (PVDF), and the like.

The methods described herein are particularly useful in providing molecules of interest in nanoscale wells or recesses upon a substrate's surface while removing such molecules from other surfaces, e.g., the top surfaces of the substrate. Of particular interest is the selected provision of molecules of interest, e.g., enzymes, within nanoscale dimensioned zero mode waveguides. Such zero mode waveguides are particularly useful as optical confinements for observing chemical reactions, and particularly enzymatic reactions that occur therein, without observing reactions that occur elsewhere above the substrate. Of particular interest are nucleic acid sequencing reactions that observe the reaction of a nucleic acid polymerizing enzyme incorporating nucleotides in a template dependent primer extension reaction. In such cases, the molecules of interest may be one part or more of the nucleic acid polymerase enzyme, the primer sequence and/or the template sequence.

While the foregoing illustrates the use of shear forces to remove the molecules of interest from selected portions of the substrate surfaces, it will be appreciated that the second surface may have an enhanced adherence to the molecules of interest so as to remove them from the selected portions of the surface through a transfer process.

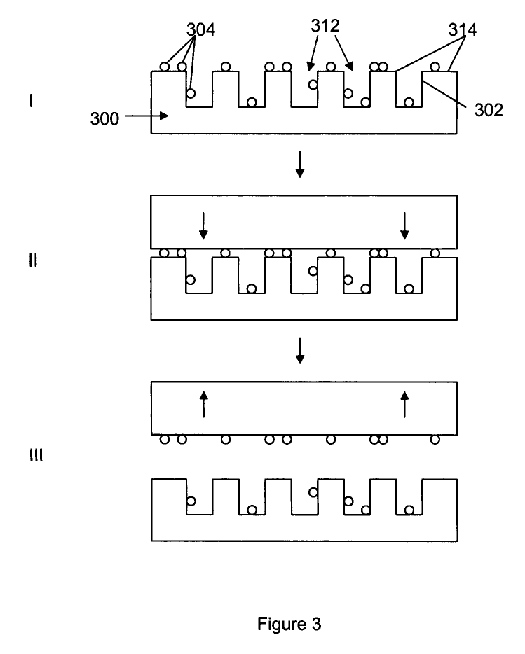

FIG. 3 schematically illustrates the use of such adsorbent or adherent surfaces in the context of a contoured first surface, e.g., as shown in FIG. 1, above. As shown, a substrate 300, having a series of wells or depressions 312 has disposed upon its overall surface 302, molecules of interest 304. A second surface 306, e.g., on second substrate 308, is then contacted with the upper surfaces 314 of substrate 300 (Panel II). Because surface 306 is more attractive to the molecules of interest than surface 302, e.g., through affinity, adhesion etc., the molecules of interest are lifted off of the points of contact between the two surfaces, leaving the molecules within the wells 312, as shown in Panel III.

A number of different adhesive materials may be employed as adherent or adsorbent second substrates to remove molecules of interest from portions of the surface of the first substrate. In particular, the second substrate surface may be provided with an adhesive material, e.g., a polymer that entrains and lifts off molecules of interest at the point of contact. Alternatively, the surface of the second substrate may possess chemical characteristics, e.g., hydrophobicity, surface charge, or the like, that is more highly attractive than the surface of the first substrate at the points of contact to preferentially adsorb the molecules of interest from the first substrate. Such adhesives include those that are generally well known in the art, such as silicone based adhesives, latex based adhesives, epoxy based adhesives, and the like.

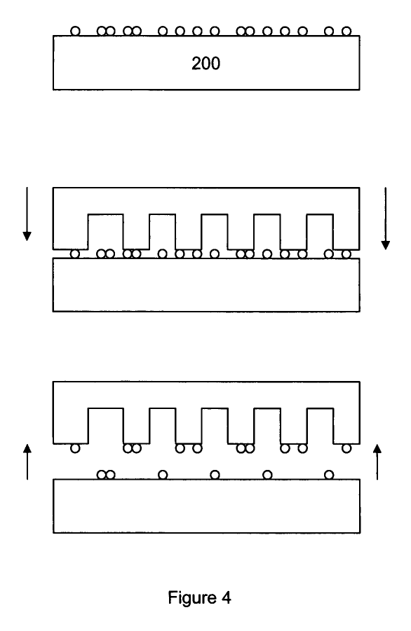

As will be appreciated, where one has provided a first surface that does not include the structure wells or recesses shown in FIG. 2, one may obtain selected removal using a patterned second substrate as a negative stamp or transfer process. In particular, and as shown in FIG. 4, a first substrate 400, shown as a planar substrate having a substantially flat upper surface 402, is provided having the molecules of interest 404 disposed thereon. A second substrate 408 that includes raised regions 412 on its surface 406 is then contacted with the upper surface 402 of the first substrate 400, such that the raised portions of the second substrate 408 are contacted with portions of the first surface of the first substrate. Where the second substrate contacts the surface of the first substrate, the molecules of interest are bound or adsorbed to the second substrate and thereby removed from the surface of the first substrate when the two substrates are separated.

The substrates prepared by the above-described processes may generally have a broad range of applications. For example, such substrates may be used in molecular array applications, where isolated groups of molecules are disposed on substrates and applied against reaction mixtures to identify the presence or absence of analytes in the solution, and/or to ascertain the reaction of the immobilized molecules with the reaction components (See, e.g., U.S. Pat. Nos. 5,143,854 and 5,489,678). In particularly preferred aspects, the invention is applied in the production of substrates having discrete reaction regions that may or may not be additionally separated by structural components. For example, the invention is particularly useful in selectively providing reactive molecules in wells or depressions in an otherwise planar substrate, either by selectively removing the active molecules from the other surfaces or by removing the coupling functionality from those surfaces prior to coupling the active molecule to the surface. As noted elsewhere herein, particularly preferred substrates along this line include arrays of nanoscale wells used as zero mode waveguides.

The substrates of the invention may be comprised of a variety of different materials, depending upon the ultimate application. Typically, such substrates will be substantially planar in an overall configuration, and will also typically have a rigid or semi-rigid structure. As such, the substrates will typically be comprised of polymeric materials, such as polymethylmethacrylate (PMMA), polystyrene, or other rigid or semi-rigid polymers, silica based substrates, like silicon, glass, quartz, fused silica, or the like, metals, like steel, aluminum, gold, platinum, or the like. In particularly preferred aspects, the substrates will be transparent and as such will be comprised of glass, quartz, fused silica or the like, or will comprise a transparent polymeric material such as PMMA. In still further preferred aspects, the substrates may comprise hybrid material structures that include both metal and silica or polymer based components.

One particularly preferred application of the methods described herein is in the selective removal of active molecules from portions of the substrate surface in zero mode waveguide arrays used for biochemical analyses. In particular, such substrates typically comprise a layered structure which includes a transparent base substrate layer and a cladding layer disposed upon one surface of the transparent substrate. The cladding layer, which typically comprises an opaque metal layer, e.g., comprising aluminum, chromium or the like, includes nanoscale apertures disposed through it to the underlying transparent substrate. These nanoscale apertures, or cores, function to prevent the propagation of light through them. Evanescent decay of light that is directed at the waveguide core thus yields a very small illuminated volume at the base of the core. Because a very small illumination volume is created, it permits the optical analysis of reactions within that volume, which can involve from one to several molecules. Further, reaction solution outside of the illumination volume does not contribute to any noise levels of the desired reaction.

In particularly preferred aspects, the zero mode waveguide arrays are used for nucleic acid sequence analysis by monitoring the polymerase mediated, template dependent incorporation of nucleotides in a primer extension reaction. In such cases, a polymerase enzyme, complexed with a template sequence and a primer sequence are provided within the illumination volume of a zero mode waveguide. The complex is exposed by the four nucleotides that are each labeled with spectrally distinguishable fluorescent labels on one of the phosphates in the polyphosphate chain, other than the alpha phosphate. Incorporation of a labeled base within the observation volume results in an extended retention of that label within the illumination volume, and consequently results in an extended fluorescent signal emanating from the illumination volume, as compared to randomly diffusing fluorescent labels. Upon incorporation, because the label is coupled to the phosphate chain, it is cleaved free from the incorporated nucleotide.

As will be appreciated, it is desirable to remove active complexes from portions of the substrate that are not being observed, e.g., non illuminated regions of the substrate, such as on the upper surfaces of the cladding layer, as such complexes may contribute to observed reactions through the production of excess label, consumption of reagents, primers, templates, and the like (See, e.g., commonly owned Published International Patent Application No. WO 2007/123763, incorporated herein by reference in its entirety for al purposes). As such, it is desirable to be able to remove such complexes from these other surfaces using, for example, the methods described herein.

In accordance with the preferred aspects of the invention as set forth above, it will be appreciated that the methods described herein may be generally used to yield substrates having molecules localized in selected locations such that individual enzymes, or enzyme/template/primer complexes may be individually optically resolved. In particular, the methods described herein may be employed as at least one step in providing substrates having arrays of a plurality of individually optically resolvable polymerase enzymes and/or complexes. Such individually resolvable enzymes or complexes may be provided within structurally confined (and/or optically confined) spaces, or they may be disposed on planar substrates, and thus must have adequate inter-molecule spacing to provide optical resolvability (See, e.g., European Patent No. 1105529, for a discussion on optical resolvability of individual molecules).

In accordance with the invention, polymerase enzymes, primers or templates, are provided immobilized upon the overall surface of the substrate, but are then substantially removed from select portions of the substrate in accordance with the methods described herein. The result is that the immobilized molecules are provided substantially only within the desired areas, e.g., within the zero mode waveguide cores.

In particularly preferred aspects, the methods of the invention are employed to assist in the immobilization of individual molecules or molecular complexes, such that each individual molecule or complex can be individually optically resolved, e.g., using fluorescence spectroscopy.

In a related aspect, the functional groups that form the sites of attachment or coupling for the polymerase enzymes may also be the active molecules of interest in accordance with the present invention. Such coupling may be via functional chemical groups, e.g., hydroxyl groups, amino groups, epoxy groups or the like. Alternatively, coupling may occur through specific binding partners, e.g., where one member of a specific binding pair is the coupling group attached to the surface (or is attached to a coupling group that is attached to the surface), and the other member of the binding pair is attached to or is integral with the molecule of interest. In particularly preferred aspects, such specific binding pairs are used to couple the molecule of interest to the surface, including, e.g., the use of avidin, streptavidin or neutravidin as one member of the binding pair, and biotin as the other member. Additionally, sandwich binding strategies may be employed, e.g., coupling biotin to the surface in the area of interest, followed by linkage to avidin, which is in turn, linked to a biotin molecule coupled to the molecule of interest. Typically, a linker silane group is used as the initial functional group. This group may be provided directly upon the surface or, as alluded to previously, diluted with similar linker silanes that are inert to additional coupling. In particularly preferred aspects, a linker silane bearing, e.g., a biotin group is immobilized in the initial step, followed by coupling of a molecule of interest, e g., a polymerase enzyme, through a bridging avidin group coupled with an enzyme linked biotin group. As will be appreciated any of a variety of different configurations may be practiced within the context of the invention.

Although described in some detail for purposes of illustration, it will be readily appreciated that a number of variations known or appreciated by those of skill in the art may be practiced within the scope of present invention. Unless otherwise clear from the context or expressly stated, any concentration values provided herein are generally given in terms of admixture values or percentages without regard to any conversion that occurs upon or following addition of the particular component of the mixture. To the extent not already expressly incorporated herein, all published references and patent documents referred to in this disclosure are incorporated herein by reference in their entirety for all purposes.

What is claimed:

1. A method of producing an array of molecules of interest on a surface of a substrate, comprising:
providing molecules of interest over a first surface of a substrate; and
contacting selected portions of the first surface of the first substrate with a second surface wherein contact of the selected portions of the first surface with the second surface applies a force that results in removal of molecules of interest from the selected portions of the first surface.

2. The method of claim 1 wherein the second surface is sufficiently adherent or adsorbent of the molecules of interest on the first surface of the first substrate to remove the molecules of interest from the selected portions of the first surface.

3. The method of claim 1, wherein the step of contacting selected portions of the first surface with the second surface comprises applying a shear force between the selected portions of the first surface and the second surface.

4. The method of claim 1, wherein the first surface comprises structural elements having raised surfaces, the raised surfaces comprising the selected portions of the first surface, and contacting the second surface when the second surface is mated to the first surface.

5. The method of claim 1, wherein second surface is adherent to the molecules of interest.

6. The method of claim 1, wherein the contacting step comprises applying a shear force to remove the molecules of interest.

7. The method of claim 1, wherein the first surface of the substrate comprises one or more recessed portions and one or more raised portions, the raised portions comprising the selected portions of the first surface.

8. The method of claim 1, wherein the substrate comprises a plurality of wells disposed in the first surface of the substrate.

9. The method of claim 1, wherein the substrate comprises a transparent substrate.

10. The method of claim 1, wherein the substrate comprises a transparent layer and a cladding layer disposed over the transparent layer, the cladding layer having a plurality of apertures disposed therethrough to expose portions of the transparent substrate, wherein a surface of the cladding layer and portions of the transparent substrate provide the first surface.

11. The method of claim 1, wherein the second surface is selected from a film or sheet of polydimethylsiloxane (PDMS), polytetrafluoroethylene (PTFE), cellulose, nitrocellulose, and polyvinyl difluoride (PVDF).

12. The method of claim 1, wherein the second surface is adsorbant or adherent of the molecules of interest.

13. The method of claim 1, wherein the second surface comprises an adhesive.

14. The method of claim 1, wherein the second surface comprises a hydrophobic material.

15. A method of producing a substrate having molecules of interest located in first selected regions thereof, comprising:
providing a first substrate having a surface with molecules of interest disposed thereon;
contacting second selected regions of the surface with a second substrate, the second selected regions being different from the first selected regions; and
providing a force between the first substrate and the second substrate to remove the molecules of interest from the second selected regions.

16. The method of claim 15, wherein the force provided is selected from a shear force and an adherent force.

17. The method of claim 15, wherein the surface of the first substrate surface comprises a plurality of low regions and a plurality of raised regions, the first selected regions being disposed in the low regions and the second selected regions being disposed upon the raised regions.

18. The method of claim 15, wherein the second substrate comprises a contoured surface that when mated with the surface of the first substrate, only contacts the second selected regions of the first substrate surface.

19. The method of claim 18, wherein the second substrate comprises a polymeric substrate.

20. The method of claim 19, wherein the molded polymeric substrate comprises a silica polymer.

21. The method of claim 20, wherein the silica polymer comprises PDMS.
